(19) United States
(12) Patent Application Publication
(10) Pub. No.: US 2012/0115355 A1
(43) Pub. Date: May 10, 2012

(54) APPLIANCE INSTALLATION DEVICE AND METHOD FOR PRODUCING THE SAME

(75) Inventors: Peter Kondor, Steinheim (DE); Andras Szekeres, Zalaegerszeg (HU)

(73) Assignee: EPCOS AG, München (DE)

(21) Appl. No.: 13/320,769

(22) PCT Filed: May 20, 2010
(86) PCT No.: PCT/EP2010/056989

§ 371 Date: Jan. 24, 2012

(30) Foreign Application Priority Data
May 20, 2009 (DE) 10 2009 022 075.5

(51) Int. Cl. H01R 13/60; B23P 11/00

(52) U.S. Cl. 439/527; 29/428

(57) ABSTRACT

An appliance installation device for connection of an electrical appliance to a power supply system comprising a connecting unit for electrical connection of the appliance installation device to the power supply system, a housing, a mounting frame which has at least one aperture opening open on two sides, wherein the connecting unit, the mounting frame and the housing each form an individual module and the individual modules are connected to one another.

### RELATED APPLICATIONS

This is a §371 of International Application No. PCT/EP2010/056989, with an international filing date of May 20, 2010 (WO 2010/133679, published Nov. 25, 2010), which is based on German Patent Application No. 10 2009 022 075.5, filed May 20, 2009, the subject matter of which is incorporated by reference.

### TECHNICAL FIELD

This disclosure relates to appliance installation devices and methods of producing such appliance installation devices.

### BACKGROUND

EP 1142071 B1 discloses an appliance installation device for connection of an electrical appliance to a power supply system. It could be helpful to provide an appliance installation device which can be produced cost-effectively and in a simple manner.

### SUMMARY

We provide an appliance installation device for connection of an electrical appliance to a power supply system including a connecting unit for electrical connection of the appliance installation device to the power supply system, a housing, a mounting frame which has at least one aperture opening open on two sides, wherein the connecting unit, the mounting frame and the housing each form an individual module and individual modules are connected to one another.

We also provide a method for producing an appliance installation device for connection of an electrical appliance to a power supply system, including providing a mounting frame which has at least one aperture opening open on both sides, providing a connecting unit in the form of a module, for electrical connection of the appliance installation device to the power supply system, providing a housing, inserting the connecting unit into the aperture opening in the mounting frame, and connecting the mounting frame and the connecting unit to the housing.

### BRIEF DESCRIPTION OF THE DRAWINGS

FIG. 1 shows an exploded drawing of the design of one example of our appliance installation device.

FIG. 2 shows a three-dimensional view of one example of our appliance installation.

FIG. 3 shows a view from the front of the appliance installation device as shown in FIG. 2.

FIG. 4 shows a plan view of the appliance installation device as shown in FIG. 2.

FIG. 5 shows a side view of the example of the appliance installation device as shown in FIG. 2.

FIG. 6 shows a view from the rear of the appliance installation device as shown in FIG. 2.

### LIST OF REFERENCE SYMBOLS

1 Appliance installation device
2 Connecting unit
3 Holder
4 Housing
5 Mounting frame
6 Aperture opening
7 Switching unit
8 Switching unit holder
9 Projection
10,10′ Holding studs
11 Latching-in opening
12 Protection unit
13 Fuse unit
14 Cover
15 Contact lug
16 Contact pin
17,17′ Hole
18 Contact surface
19 Hole

### DETAILED DESCRIPTION

Our appliance installation device is specified for connection of an electrical appliance to a power supply system, which device has a connecting unit for electrical connection of the appliance installation device to the power supply system. One example of the connecting unit comprises a holder (IEC plug) for an appliance coupling, with which the appliance can be connected to the power supply system via the appliance installation device. The appliance installation device has a housing. The appliance installation device furthermore has a mounting frame which comprises at least one aperture opening which is open on both sides. The connecting unit, the mounting frame and the housing of the appliance installation device are designed such that they each form an individual module. The individual modules of the appliance installation device are connected to one another to form the device.

The connecting unit may be passed through the at least one aperture opening in the mounting frame and latched to the housing.

The mounting frame may be connected by a latching device to the housing of the appliance installation device. The mounting frame may also be fixed by the connecting unit, which is latched to the housing, and connected to the housing.

The appliance installation device may comprise a single-phase or two-phase switching unit. The switching unit is mechanically connected to the mounting frame.

The mounting frame may have a holding depression or opening for the switching unit into which the switching unit can be inserted. The switching unit is preferably connected to the mounting frame such that it can be latched.

The connecting unit, the mounting frame, the switching unit and the housing may have holding studs and/or corresponding latching-in openings. The holding studs or the associated latching-in openings are surrounded by a latching device with which the individual modules can be connected to one another, at least partially detachably or non-detachably.

The connecting unit may have at least one protection unit which comprises a line filter.

The at least one protection unit of the appliance installation device may be electrically connected to the connecting unit and is designed such that it protects the electrical appliance against interference from the power supply system, and/or protects the power supply system against interference from the electrical appliance. However, depending on the structure or purpose, the at least one protection unit may also be designed in the form of a fault-current circuit or as a motor protection circuit breaker, and/or may be designed as an automatic fuse, with the relevantly known advantages.

The connecting unit may have a fuse unit. The fuse unit may also comprise at least one fuse holder which is intended for at least one phase of the connecting unit. The fuse holder may preferably be provided for each phase of the connecting unit.

The fuse holder may be accessible from the outside of the appliance. The fuse holder has a detachable cover to protect the fuse unit. This has the advantage that the fuses can easily be replaced.

Access to the fuse unit from the outside of the appliance has the particular advantage that a visual inspection can be carried out from the outside of the appliance.

The cover on the fuse holder ensures adequate direct-contact protection.

The housing may be composed of metal. The housing is preferably used for shielding. This results in the advantage that the connected units are protected against, in particular, radio-frequency electromagnetic interference from the environment, and the environment is protected against electromagnetic interference from the connected units.

Furthermore, a method is specified for producing an appliance installation device for connection of an electrical appliance to a power supply system. This method comprises the following steps. First, a mounting frame is provided which has at least one aperture opening which is open on both sides. Furthermore, a connecting unit is provided which comprises an individual module and is used for electrical connection of the appliance installation device to the power supply system. In the next step, a housing is provided, wherein the connecting unit is inserted into the aperture opening in the mounting frame, and the mounting frame and the connecting unit are mechanically connected to the housing.

The mechanical connection is provided, in particular, by latching the modules with the aid of a latching device.

A switching unit which is provided may be latched to the mounting frame.

The individual units may be mounted on the housing without the use of tools. To mount the individual modules on one another, they have a latching device with holding studs and/or latching-in openings with which the individual modules can be latched to one another without the use of tools.

In particular, the modular design of the appliance installation device as described above makes it possible to reduce the tool costs. Further series of appliance installation device variants can be produced without having to change the production tools. The modular design allows a high level of variability and versatility for fittings for the appliance installation devices. Both the assembly time and the assembly convenience are improved by assembly without the use of tools. Because the connections for the individual appliance installation device parts can be latched in, repairs can be carried out and/or the appliance installation device can be broken down into its individual parts for separate disposal in a simple manner.

Our devices and methods will be explained in more detail with reference to the following figures and the examples.

The drawings described in the following text should not be considered as being true to scale and, in fact, the illustrations may be shown with individual dimensions enlarged, reduced or else distorted. Elements which are the same as one another or carry out the same function are annotated with the same reference symbols.

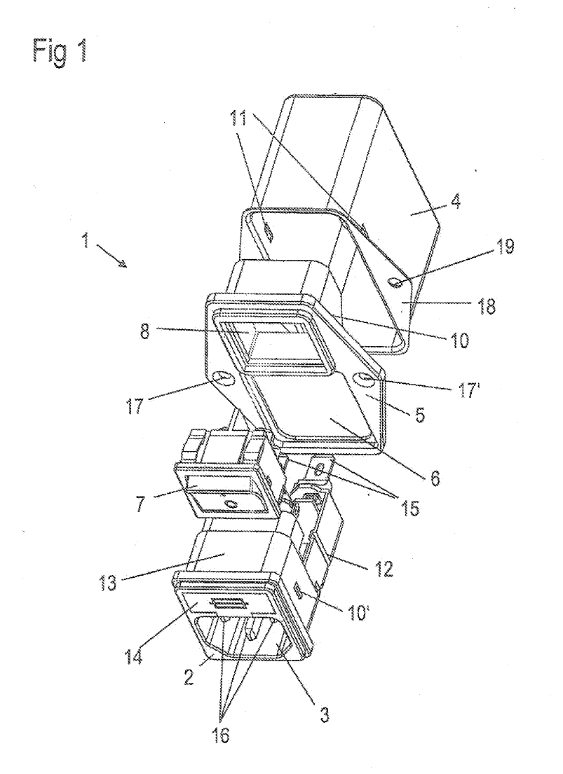

FIG. 1 shows an exploded drawing of the design of an appliance installation device 1. The illustrated example of the appliance installation device 1 comprises a connecting unit 2 which is plugged into an aperture opening 6 in the mounting frame 5. The mounting frame 5 is connected to the housing 4 of the appliance installation device 1 with a latching device 10, 11. The mounting frame 5 has a switching unit holder 8 into which a switching unit 7 can be latched or inserted. The mounting frame 5 is connected to latching-in openings 11 in the housing 4 via holding studs 10. The connecting unit 2 is likewise connected to latching-in openings 11 in the housing 4 via holding studs 10′. On two opposite sides of the front edge, the housing 4 has triangular contact surfaces 18 which are each provided with a hole 19. The contact surfaces 18 are used, for example, as a contact surface for the appliance installation device 1 on the housing of an appliance in which the appliance installation device 1 is used and, on the other hand, for contacting the mounting frame 5 which is provided with corresponding contact surfaces. To fit the appliance installation device 1 into an appliance, the holes 19 are aligned concentrically with the holes 17 in the mounting frame 5.

The connecting unit 2 in the illustrated example of the appliance installation device 1 has a fuse unit 13. The fuse unit 13 comprises a fuse holder arranged in the interior of the fuse unit 13 and accessible from the outside via a cover 14. The connecting unit 2 furthermore comprises a protection unit 12 which, for example, comprises a line filter. For electrical connection of the appliance installation device 1 to the power supply system, the illustrated example of the connecting unit 2 has a holder 3 for a refrigerator coupling (IEC plug), which has three contact pins 16. One contact pin 16 is in each case provided for the phase, for the neutral conductor and for the protective-earth conductor. The contact pins 16 are electrically connected to the protection unit 12, to the fuse unit 13, to the switching unit 7 and to the contact lugs 15 on the rear face of the housing 4. The contact lugs 15 are used for electrical connection of an appliance, in which the appliance installation device is used, to the power supply system. In a normal arrangement for refrigerator plugs, the contact pins 16 are arranged in the form of a triangle.

In the illustrated example, the switching unit 7 may be in the form of a single-phase or two-phase switch. The switching unit 7 and the connecting unit 2 are connected to one another via electrical lines, which are not shown in the illustrated example.

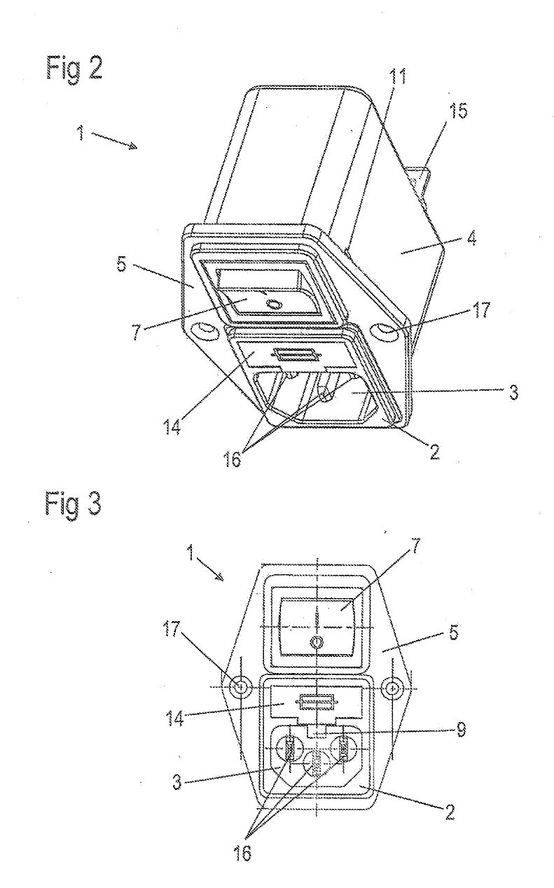

FIG. 2 shows an assembled appliance installation device 1 as shown in the exploded illustration in FIG. 1. The switching unit 2 is latched via an aperture opening 8 in the mounting frame 5 to the housing 4 via holding studs and latching-in openings 11. In the illustrated example, the appliance installation device 1 has a fuse unit 13 which is accessible from the outside via a cover 14. In the illustrated example, the appliance installation device 1 has a switching unit 7. The switching unit 7 is arranged in an opening or holder 8 in the mounting frame 5, and is connected thereto. On the rear face, the appliance installation device 1 has contact lugs 15, which are provided for electrical connection in the appliance interior and are at least partially electrically isolated from the housing 4. In the illustrated example, the connecting unit 2 has three contact pins 16 which are in a conventional arrangement for refrigerator plugs.

FIG. 3 shows a front view of the example of the appliance installation device 1 shown in FIG. 2. As can be seen from FIG. 3, the projection of the contact pins 16 of the connecting unit 2 forms a triangle. The contact pins 16 are arranged in a holder 3. The holder 3 is used for connection of a refrigerator coupling. In the illustrated example, the holder 3 has a projection 9 which prevents the cover 14 on the fuse unit from being opened when the appliance coupling is inserted. In one example of the appliance installation device for warmer and heater plugs (C15 and C15a) the projection 9 prevents refrigerator couplings from being used in a holder 3 for warmer and heater plugs. The corresponding coupling preferably has a matching cut-out, corresponding to the projection 9.

The holder 3 of the appliance installation device is, however, not restricted to warmer and heater plugs. In a further example, which is not illustrated, the holder may also be designed without the projection 9, as a result of which the holder 3 is suitable, for example, for refrigerator plugs.

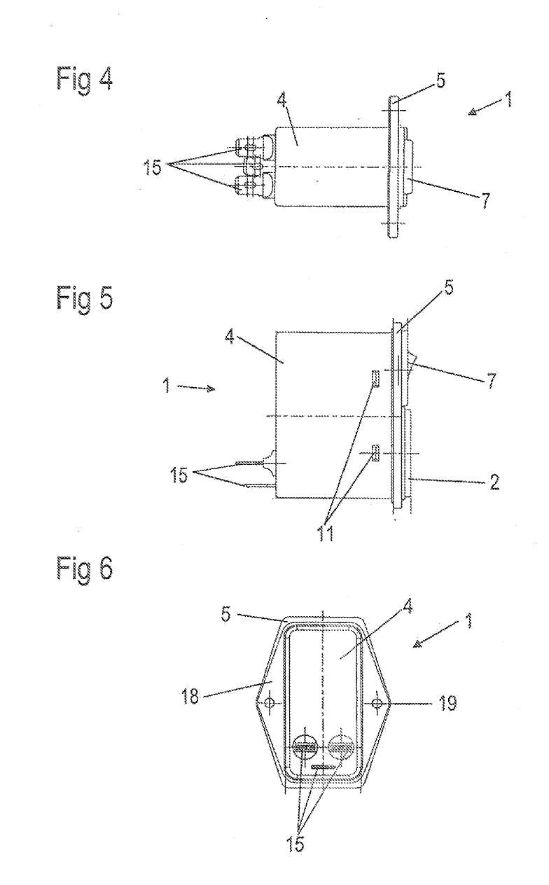

FIG. 4 shows a plan view of the example of the appliance installation device 1 as shown in FIG. 2. In the illustrated example, three connecting contact lugs 15 are illustrated on the rear face of the housing 4, and are provided for electrical connection of the appliance installation device in the interior of a housing. The mounting frame 5 is arranged on the opposite side.

FIG. 5 shows a side view of the example of the appliance installation device 1 as shown in FIG. 2. FIG. 5 shows the latching-in openings 11 which connect the mounting frame 5 and the switching unit 2 to the housing 4. In the illustrated example, the appliance installation device 1 has a switching unit 7. Contact lugs 15 are arranged on the rear face of the housing 4 with at least two of the contact lugs 15 associated with the phase and the neutral conductor being electrically isolated from the housing 4.

FIG. 6 shows a rear view of the appliance installation device 1. On the rear face of the housing, the appliance installation device 1 has three contact lugs 15 arranged at least partially offset with respect to one another. Two of the contact lugs 15 associated with the phase and the neutral conductor are electrically isolated from the housing 4. The contact lug 15 for the protective-earth conductor is connected to the housing. In the illustrated example, the mounting frame 5 has a hexagonal shape. On each of its sides, the housing 4 has a contact surface 18 used as a contact surface for the appliance installation device 1 on the housing of the appliance. The contact surface 18 in each case has a hole 19 arranged such that it concentrically overlaps the hole 17 in the mounting frame 5. The appliance installation device 1 can be attached to an appliance housing, for example, by screws, via the hole 17 in the mounting frame 5 and the hole 19 in the contact surface 18.

In a further example which is not illustrated, the mounting frame also has holding studs with which the appliance installation device can be latched in a holding opening in the appliance.

Although it has been possible to describe only a limited number of possible structures in the examples, this disclosure is not restricted to such structures. In principle, it is possible for the appliance installation device and the mounting frame of the appliance installation device to comprise further openings which are used to hold further modules. As illustrated in the figures, the appliance installation device can be assembled by screws. However, attachment to the appliance housing is also possible by latching.

The description of the subject matter herein is not restricted to the individual specific examples: in fact, the features of the individual examples can be combined with one another as required, while technically worthwhile.

1. An appliance installation device for connection of an electrical appliance to a power supply system comprising:
a connecting unit for electrical connection of the appliance installation device to the power supply system;
a housing;
a mounting frame which has at least one aperture opening open on two sides;
wherein the connecting unit, the mounting frame and the housing each form an individual module and
individual modules are connected to one another.

2. The appliance installation device according to claim 1, wherein the connecting unit passes through the at least one aperture opening in the mounting frame and is latched to the housing.

3. The appliance installation device according to claim 2, wherein the mounting frame is latched to the housing.

4. The appliance installation device according to claim 1, further comprising a single-phase or two-phase switching unit mechanically connected to the mounting frame.

5. The appliance installation device according to claim 1, wherein the connecting unit, the mounting frame, the switching unit and the housing have holding studs and/or corresponding latching-in openings.

6. The appliance installation device according to claim 1, wherein the connecting unit has at least one protection unit with a line filter.

7. The appliance installation device according to claim 6, wherein the at least one protection unit protects the electrical appliance against interference from the power supply system and/or the power supply system is protected against interference from the electrical appliance.

8. The appliance installation device according to claim 1, wherein the connecting unit has a fuse unit.

9. The appliance installation device according to claim 8, wherein the fuse unit comprises at least one fuse holder for at least one phase.

10. The appliance installation device according to claim 9, wherein the fuse holder is accessible from outside of the appliance and has a detachable cover.

11. The appliance installation device according to claim 1, wherein the housing is composed of metal.

12. A method for producing an appliance installation device for connection of an electrical appliance to a power supply system, comprising:
providing a mounting frame which has at least one aperture opening open on both sides;
providing a connecting unit in the form of a module, for electrical connection of the appliance installation device to the power supply system;
providing a housing;
inserting the connecting unit into the aperture opening in the mounting frame, and connecting the mounting frame and the connecting unit to the housing.

13. The method according to claim 12, wherein the mounting frame and the connecting unit are connected to the housing by latching with a latching device.

14. The method according to claim 12, wherein a switching unit is latched to the mounting frame.

15. The method according to claim 12, wherein individual units are mounted on the housing without tools.
